(19) United States
(12) Patent Application Publication
(10) Pub. No.: US 2007/0239543 A1
(43) Pub. Date: Oct. 11, 2007

(54) Promotional system

(75) Inventor: Andrew Franklin Robinson, Auckland (NZ)

Correspondence Address: YOUNG & THOMPSON, 745 SOUTH 23RD STREET, 2ND FLOOR, ARLINGTON, VA, 22202, US

(73) Assignee: AMMAS. COM LIMITED, AUCKLAND (NZ)

(21) Appl. No.: 11/709,783

(22) Filed: Feb. 23, 2007

(30) Foreign Application Priority Data
Feb. 24, 2006 (NZ) 545529

(51) Int. Cl. G06Q 30/00; G06F 15/02

(52) U.S. Cl. 705/14; 705/9

(57) ABSTRACT

The invention consists in a promotional system useable on a network. The network provides means for experts to answer questions submitted by enquirers. Means are provided for an advertiser to offer advertisements to experts and further means are provided to allow individual experts to either supply or not supply the advertising material supplied by the advertiser to the expert.

This invention relates to a promotional system and has been devised particularly for use on networks such as the internet.

As in most media the use of advertisements to generate revenue is widely used on the internet and other networks. In most internet advertisement systems the advertiser bids on keywords, however, this has its disadvantages that advertisers may end up advertising on a web page of inappropriate web page proprietors. This is particularly disadvantageous where the web page proprietor is in fact providing an information service as the advertiser could find themselves advertising on a web page where the advice provided by the information service is inadequate as a vehicle to support the advertisement.

Also frequently web publishers are paid by the number of clicks and this can lead to abuse, for example, by web publishers clicking on advertisements on their own website to increase the apparent number of clicks on the advertisement.

It is therefore an object of the present invention to provide a promotional system which will obviate or minimise the foregoing disadvantages in a simple yet effective manner or which will at least provide the public with a useful choice.

Accordingly in one aspect the invention consists in a promotional system useable on a network, the network providing means for experts to answer questions submitted by enquirers, wherein a means is provided for an advertiser to offer advertisements to experts and wherein means is provided to allow individual experts to either supply or not supply the advertising material supplied by the advertiser to the expert.

Preferably means are provided to allow the advertiser to offer payment to the expert based on one or both of referrals and click throughs.

Preferably means are provided to substantially prevent false clicks.

Preferably means are provided to specify recommendations to end users by location and/or status of the enquirer and/or category of product or service.

Preferably means are provided to allow payment to be offered by the advertiser either at a standard rate, or a rate determined per expert.

Preferably means are provided to optionally allow advertisements to be emailed to enquirers.

Preferably the advertiser is able to offer the advertisement to one or selected experts.

Preferably the experts are ranked and the rankings are made available to potential advertisers.

In a further aspect the invention consists in a promotional system useable on a network, the network providing means for experts to answer questions submitted by enquirers, wherein a means is provided to substantially prevent false clicks.

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

One preferred form of the invention will now be described with reference to the accompanying drawings in which,

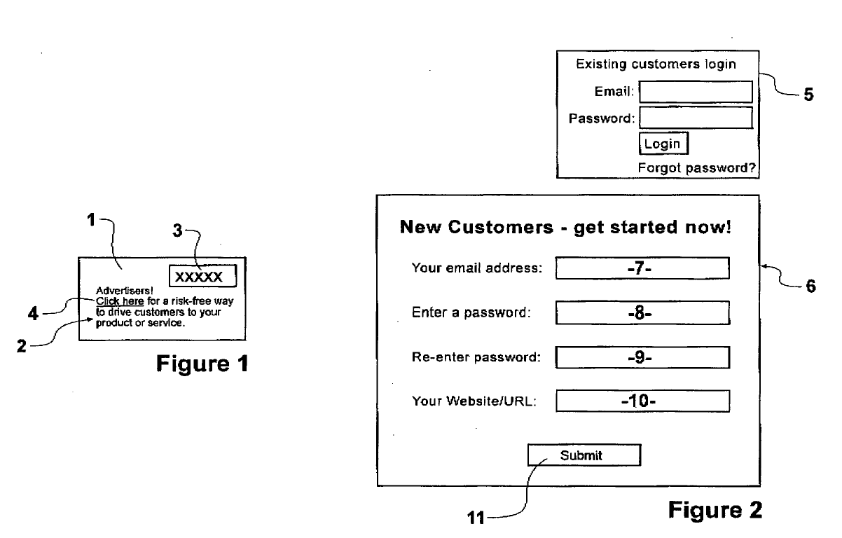

FIG. 1 is a possible layout for a link to allow advertisers to access to a promotional system when provided on a network such as the internet,

FIG. 2 is a possible information entry page for advertisers on the network,

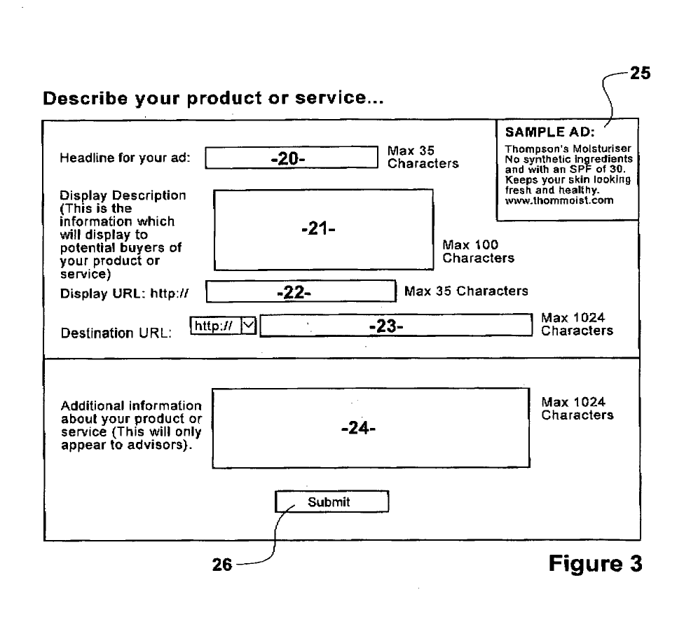

FIG. 3 shows a possible advertisement capture sheet for use in relation to the use of the invention,

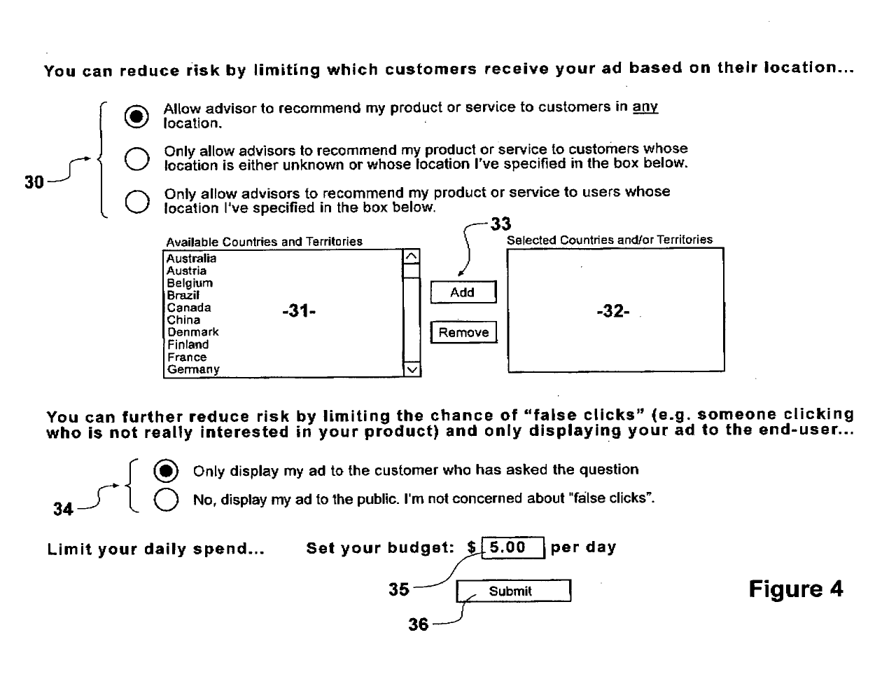

FIG. 4 is a further sheet allowing options to the potential advertiser for use in the invention,

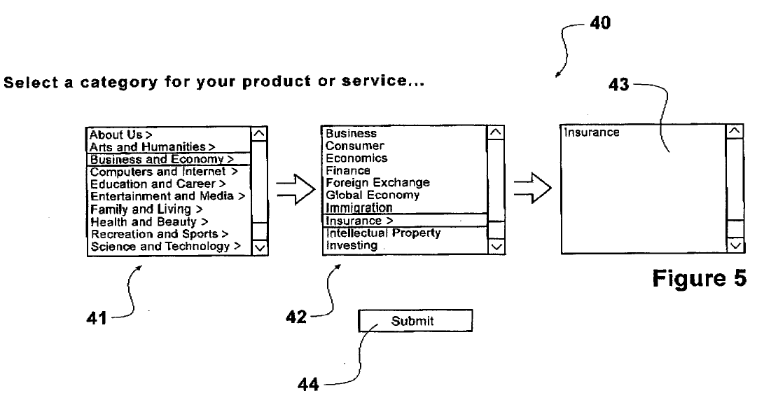

FIG. 5 allows further options for the advertiser,

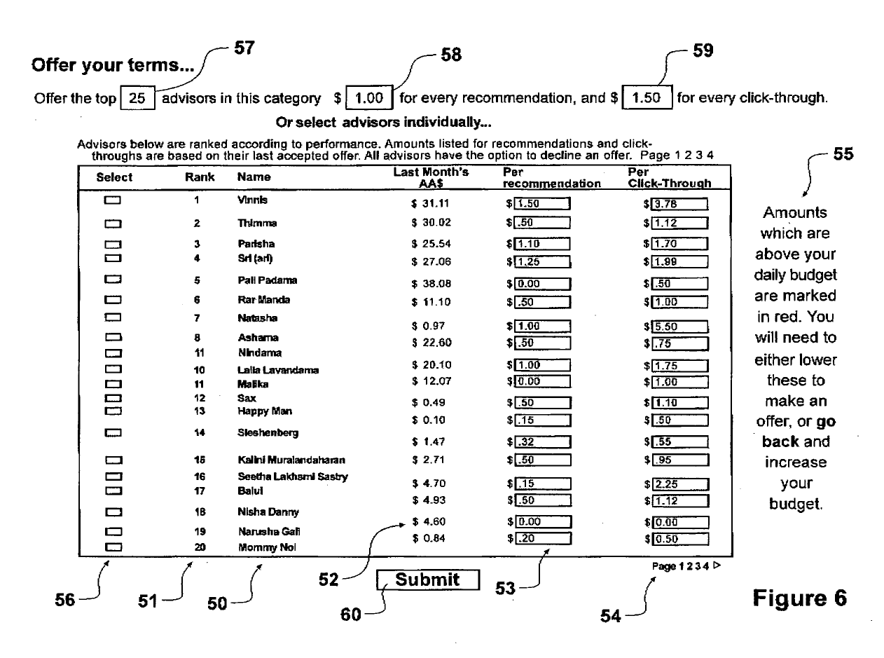

FIG. 6 is a potential data input sheet allowing the advertiser to offer their terms to experts able to utilise the advertisements on the system of the invention,

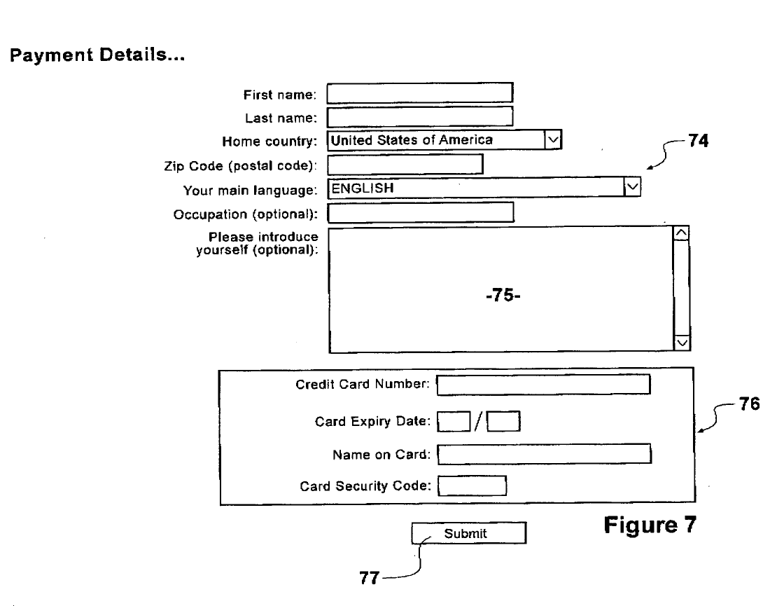

FIG. 7 is a payment details input sheet,

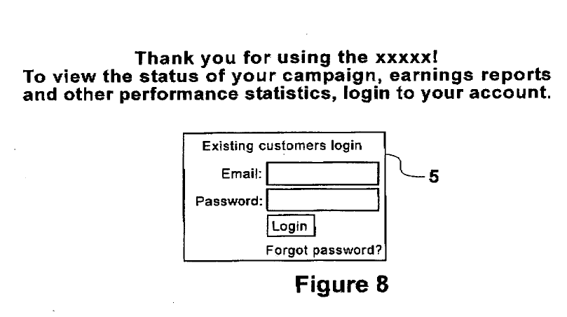

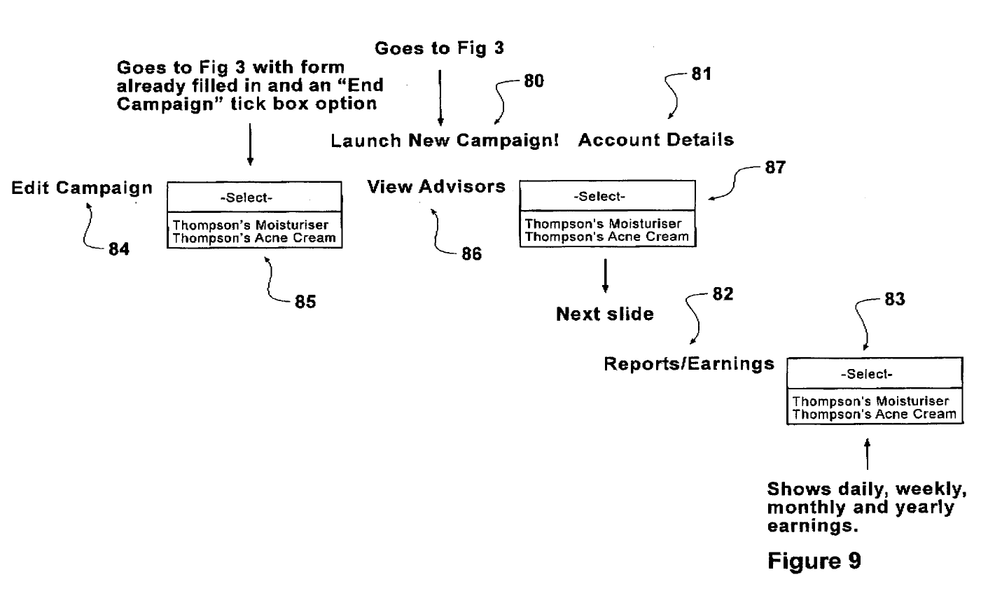

FIG. 8 shows a possible final page after setting up an account according to the invention,

FIG. 9 is a schematic representation of parts of the system,

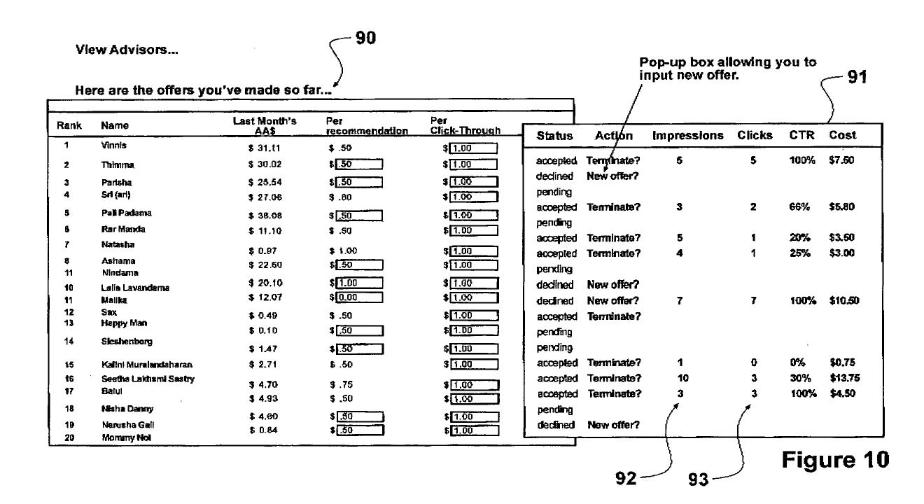

FIG. 10 shows a input screen for allowing an advertiser to edit or change the offers made to various experts providing information on the network and providing further information to the advertiser,

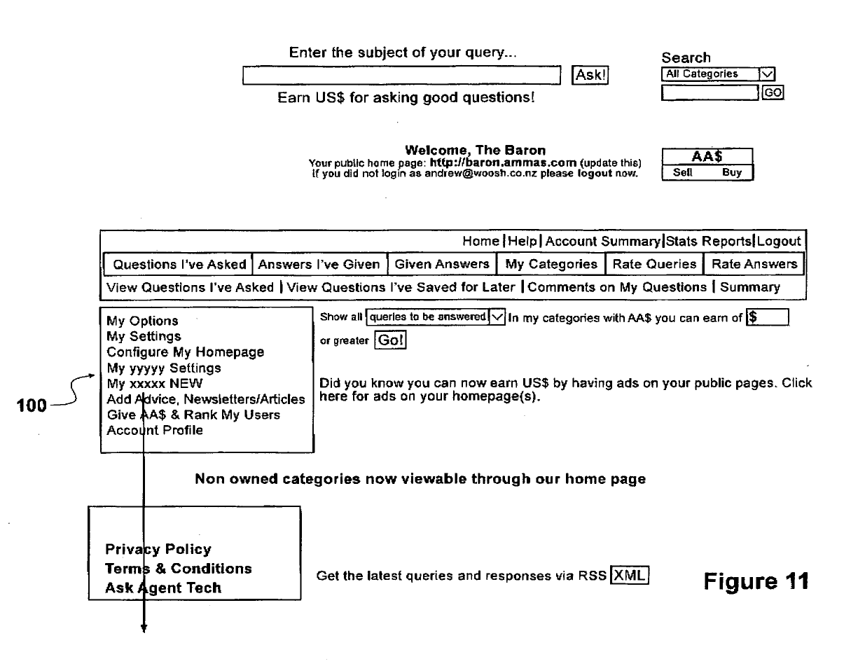

FIG. 11 shows a further information page available to users of the network,

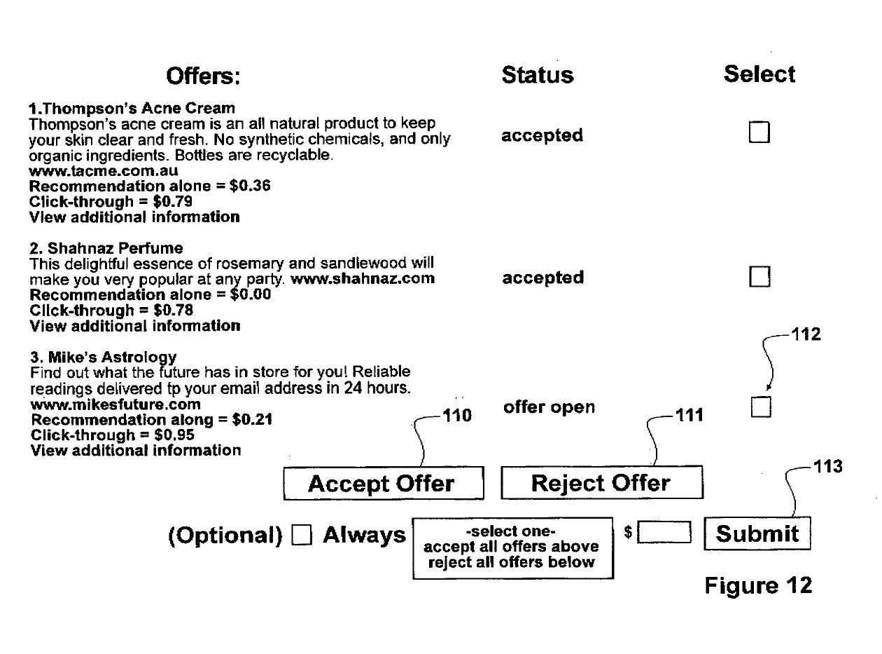

FIG. 12 shows a page which an advice offering expert is able to accept or reject advertising offers,

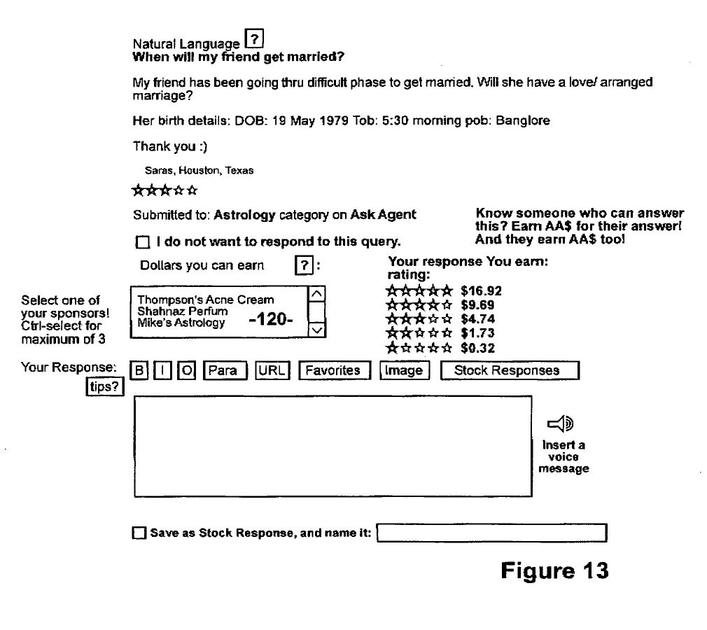

FIG. 13 shows a list of advertisers on an expert's response page,

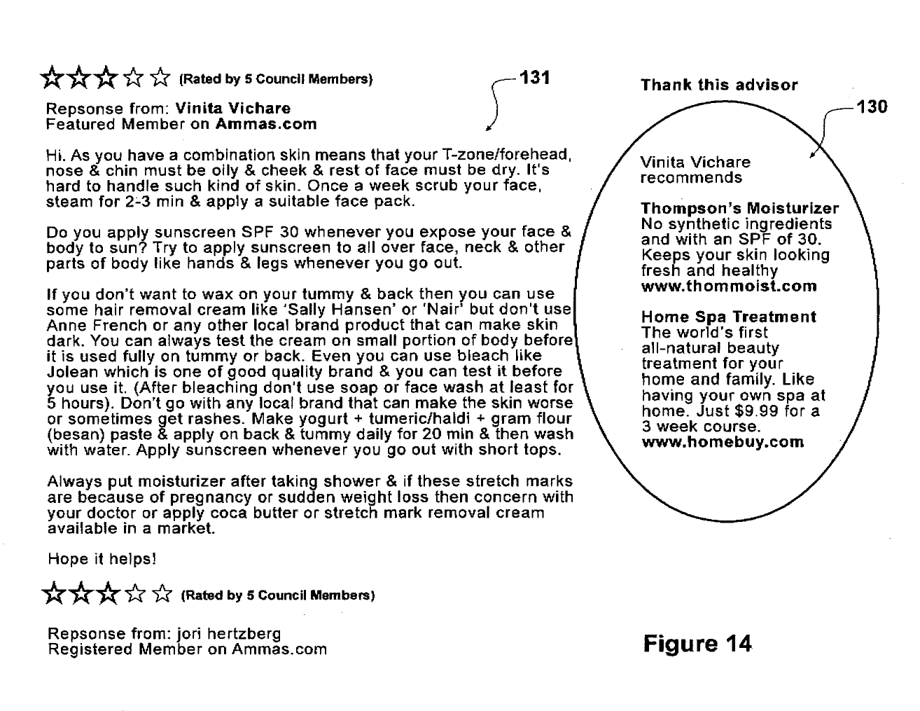

FIG. 14 shows advertisements on as expert's answer page,

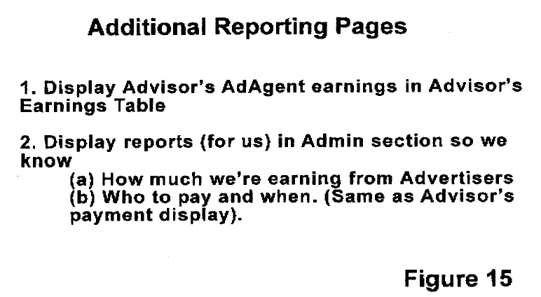

FIG. 15 lists possible additional reporting pages.

Referring to the drawings FIG. 1 shows a possible link 1 which can be inserted onto, for example, home pages or other pages of the internet or other networks. The link comprises a message 2, for example, a banner or trade mark 3 and a position 4 for a potential advertiser to click to be taken to the screen shown in FIG. 2. A typical existing customers login box 5 is provided and a new customers login box 6 asking typical questions such as email address at 7, a user selected password at 8, a box 9 to re-enter the password, a box 10 to enter the address of the users website or URL, and a submit button 11.

These boxes could be supplemented by promotional material relating to the advertising service if desired, for example, the potential advertiser could be advised that links to the product or website not only appear on the website but go out (optionally) as an email to the end user. Because of the setup of the system, as will be described further hereinafter, the ad is only displayed when the customer is likely to buy, thereby keeping costs down. As again will be further mentioned an option is available to prevent “false clicks”, by only allowing the end customer to click on the ad. The potential advertiser can also be told that in general the advertisements will only be supplied to enquirers to the network who are looking for assistance in the area to which the advertisement relates.

When submit button 11 is pressed the potential advertiser is taken to the screen of FIG. 3 which allows inputting of a headline in box 20, a displayed description at 21, which may have maximum, for example, 100 characters, a URL to display at 22 and the destination URL at 23 which may be the same or different to the display URL.

It also desirable to provide a further box, at 24 to allow additional information about the product which can be used by the advisers on the network when deciding whether to apply this particular advertisement or not. A sample advertisement can be provided at 25 and again a submit button at 26.

Clicking submit button 26 takes the potential advertiser to the screen the subject of FIG. 4.

Options are provided at 30 as to how the adviser should recommend the product in relation to location. Available countries can be provided in box 31 and selected countries can be displayed in box 32 through the use of “addition” or “remove” buttons at 33.

The option to limit the chance of false clicks is provided at 34.

An advertising budget can be entered at box 35 and again a submit button is provided at 36.

The submit button 36 takes the potential advertiser to the screen in FIG. 5 which allows selection of a category for the product or service as at 40. Typically there will be a rough sort at 41, the selection of which brings up finer options at 42 allowing selection of those appropriate in box 43. Again a submit button 44 is provided.

Operation of the submit button 44 takes the user to the screen at FIG. 6 which lists advisers in column 50 and their ranking preferably determined by the operators of the information network at 51.

Column 52 can indicate to the advertiser at subsequent visits to this page, how much the advertiser has earned from particular advisers and allows the potential advertiser to enter a price per recommendation at 53, and a price per click through at 54. The system also allows amounts above the daily budget to be marked in an alternative colour such as red and to provide such advice as seen at 55.

A column 56 is provided to indicate whether a particular advisor has been selected or otherwise.

Box 57 indicates the number of advisors that the advertiser wants to select in an alternative when each advisor is provided the same funding for example for every recommendation in box 58 and every click through in box 59.

A submit button 60 is again provided clicking on which takes the potential advertiser to the screen indicated at FIG. 7, which shows payment details.

Boxes at 74 provide information as to the potential advertiser including if desired some personal information in box 75. Typical credit card information is provided at 76 and again a submit button at 77. Clicking the submit button 77 takes the user to the screen in FIG. 8 which thanks the advertiser and again provides a login screen 5 substantially as shown in FIG. 2.

Logging in includes among its options the screen shown on FIG. 9. Should the potential advertiser wish to launch a new campaign the wording at 80 can be clicked and the user will be returned to the screen in FIG. 3 to commence the new campaign.

Account details can be obtained by clicking at 81 and reports and earnings by clicking at 82. When clicking at 82 the particular product can be selected from box 83 and information such as daily, weekly, monthly and yearly earnings obtained.

Should the advertiser wish to edit the campaign the wording at 84 can be clicked and the particular advertisement selected at 85.

This will again take the advertiser to screen 3 but with the form already filled in and also an “end campaign” tick box option is provided on the form.

If the new providers wording is clicked at 86 then the advertiser is taken to the slide at FIG. 10 when the desired advertisement is selected from the selection box 87.

In FIG. 10 a list of offers made so far is provided at 90 and a popup box 91 is provided allowing offers to be terminated and new offers made.

The columns 92 show impressions and clicks and other relevant information is provided in box 91.

FIG. 11 shows a page that can be accessed by an enquirer and allows at item 100 the enquirer and/or advisor to enable them to place advertisements on their public pages.

Clicking on the wording at 100 takes the enquirer/advisor to the screen on FIG. 12 where available advertisements are listed which can be accepted by clicking button 110 or rejected by clicking 111 after selection in column 112.

Once the appropriate selection has been made submission button 113 is operated taking the user to FIG. 13 which lists the selected advertisements at 120. FIG. 14 shows at 130 advertisements that have been added by an advisor to an answer or query provided at 131.

FIG. 15 shows some further reporting pages that can be made available to a user.

The messages shown in FIG. 14 at box 130 are displayed if the advertiser has chosen to display their advertisements to the public otherwise the endorsements only go out in the email notification provided as part of the answer and appear in the asking users login “view questions”. The advertisements also need to appear to advisors when they are rating queries if this option is provided. This step assists to ensure that the advisors provide the right ads at the right time.

Thus it can be seen that at least in the preferred form of the invention a promotional system is provided which enables advertisers to bid on individual experts of the advising panel. The advertiser is able to select experts from a ranked list. The expert (that is to say the advisor) decides whether or not the advertisement is appropriate for the person who is asking the question. This minimises the risk of the advertisement being provided on an inappropriate web page when taken together with the ability of the advertiser to select experts who can place the advertiser's advertisement. Selection of expert also minimises the risk of the advertisement being run in association with poor advice. It is of particular advantage of the preferred form of the invention that where the system ranks members advertisers can know who is good and who is not and bid accordingly. This system can prevent false click throughs by delivering the ad only to persons who have asked a question directly to the appropriate end user by email.

What we claim is:

1. A promotional system useable on a network, the network providing means for experts to answer questions submitted by enquirers, wherein a means is provided for an advertiser to offer advertisements to experts and wherein means is provided to allow individual experts to either supply or not supply the advertising material supplied by the advertiser to the expert.

2. A promotional system as claimed in claim 1 wherein means are provided to allow the advertiser to offer payment to the expert based on one or both of referrals and click throughs.

3. A promotional system as claimed in claim 1 wherein means are provided to substantially prevent false clicks.

4. A promotional system as claimed in claim 1 wherein means are provided to specify recommendations to end users by location and/or status of the enquirer and/or category of product or service.

5. A promotional system as claimed in claim 1 wherein means are provided to allow payment to be offered by the advertiser either at a standard rate, or a rate determined per expert.

6. A promotional system as claimed in claim 1 wherein means are provided to optionally allow advertisements to be emailed to enquirers.

7. A promotional system as claimed in claim 6 wherein the advertiser is able to offer the advertisement to one or selected experts.

8. A promotional system as claimed in claim 7 wherein the experts are ranked and the rankings are made available to potential advertisers.

9. A promotional system useable on a network, the network providing means for experts to answer questions submitted by enquirers, wherein a means is provided to substantially prevent false clicks.
